(19) United States
(12) Patent Application Publication
(10) Pub. No.: US 2022/0318290 A1
(43) Pub. Date: Oct. 6, 2022

(54) SYSTEM AND METHOD FOR CONTENT CREATION AND MODERATION IN A DIGITAL PLATFORM

(71) Applicants: VIDYA NARAYANAN, San Jose, CA (US); LAKSHMINATH REDDY DONDETI, San Jose, CA (US)

(72) Inventors: VIDYA NARAYANAN, San Jose, CA (US); LAKSHMINATH REDDY DONDETI, San Jose, CA (US)

(21) Appl. No.: 17/712,368

(22) Filed: Apr. 4, 2022

Related U.S. Application Data
(60) Provisional application No. 63/170,578, filed on Apr. 5, 2021.

(51) Int. Cl. G06F 16/41; G06Q 50/00

(52) U.S. Cl. CPC G06F 16/41; G06Q 50/01

(57) ABSTRACT

Exemplary embodiments of the present disclosure are directed towards a system and method for content creation and moderation in a digital platform, comprising computing devices configured to establish communication with server over network; a content creation module enabling a user or creator to create content by a content creation module, the server comprises a content moderation module configured to detecting and analyzing the created content by, identifying historical context, topic expertise level, and a score of the content by the content moderation module, moderating the content based on the historical context, topic expertise level, and the score of the content by the content moderation module, allowing end-users to access the moderated content by the content creation module thereby understanding the topic expertise level and the historical context of the content creator based on topics.

### CROSS-REFERENCE TO RELATED APPLICATIONS

This patent application claims priority benefit of U.S. Provisional Patent Application No. 63/170,578, entitled “METHOD AND APPARATUS FOR SOURCE REPUTATION, IDENTITY AND CONTENT MODERATION IN SOCIAL NETWORKS”, filed on 5 Apr. 2021. The entire contents of the patent application are hereby incorporated by reference herein in its entirety.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to automatically identifying and displaying topic-level expertise and historical context of the source of information in a digital platform. More particularly, the present disclosure relates to a system and computer-implemented method for automatic labeling and moderation of sensitive and controversial content.

### BACKGROUND

Social media has led to paradigm shifts in the ways people work and does business, interact, socialize, learn and obtain knowledge. So much so that social media has established itself as an essential spatial extension of this nation's historicity and challenges. Some existing social networks compute and display the overall standing of the user on the network. In some cases, the user's expertise on a topic is explicitly set by the user itself.

In the light of the aforementioned discussion, there exists a need for a certain system to content creation and moderation in digital platform computing devices with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards enabling the user to register or continue as the new user (guest user).

Another objective of the present disclosure is directed towards generating karma points to the registered user and the new user (guest user).

Another objective of the present disclosure is directed towards enabling the user to share the created content as at least one of: anonymously; a user identity.

Another objective of the present disclosure is directed towards enabling the user to create the profile and allow the user to add their current location in a user profile.

Another objective of the present disclosure is directed towards allowing the user to share the created content as at least one of: publicly; with selected friends by a content visibility configuration module.

According to an exemplary aspect of the present disclosure is directed towards enabling a user or creator to create content by a content creation module enabled in a computing device.

According to another exemplary aspect of the present disclosure is directed towards detecting and analyzing the created content by a content moderation module enabled in a server.

According to another exemplary aspect of the present disclosure is directed towards identifying historical context, topic expertise level, and a score of the content by the content moderation module.

According to another exemplary aspect of the present disclosure is directed towards moderating the content based on the historical context, topic expertise level, and the score of the content by the content moderation module.

According to another exemplary aspect of the present disclosure is directed towards allowing one or more end-users to access the moderated content by the content creation module thereby understanding the topic expertise level and the historical context of the content creator based on one or more topics.

According to another exemplary aspect of the present disclosure is directed towards allowing the one or more end-users to judge the authenticity and trustworthiness of the content based on the topic expertise level and the historical context of the content creator on one or more topics by a reputation authentication module of the content creation module.

According to another exemplary aspect of the present disclosure is directed towards detecting popularity of the content based on the one or more end-users views and interactions thereby updating the topic expertise level of the content creator and the score of the content.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system for content creation and moderation in a digital platform, in accordance with one or more exemplary embodiments.

FIG. 2 is a block diagram depicting an embodiment of the content creation module 114 on the computing devices and the content controlling module 116 on the server of shown in FIG. 1, in accordance with one or more exemplary embodiments.

FIG. 3 is a flow diagram depicting a method for registering and logging process into a content creation module with verified status and karma points, in accordance with one or more exemplary embodiments.

FIG. 4 is a flow diagram depicting a method for establishing and verifying a user profile, in accordance with one or more exemplary embodiments.

FIG. 5 is a flow diagram depicting a method for posting content in the content creation module 114 on the computing devices, in accordance with one or more exemplary embodiments.

FIG. 6 is a flow diagram depicting a method for updating a user skills and karma points based on posted content, in accordance with one or more exemplary embodiments.

FIG. 7 is a flow diagram depicting a method for automatically detecting the user skills based on posted content, in accordance with one or more exemplary embodiments.

FIG. 8 is a flow diagram depicting a method for automatically correcting the user skills, in accordance with one or more exemplary embodiments.

FIG. 9 is a flow diagram depicting a method for content creation and moderation in a digital platform, in accordance with one or more exemplary embodiments.

FIG. 10 is a block diagram illustrating the details of a digital processing system 1000 in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

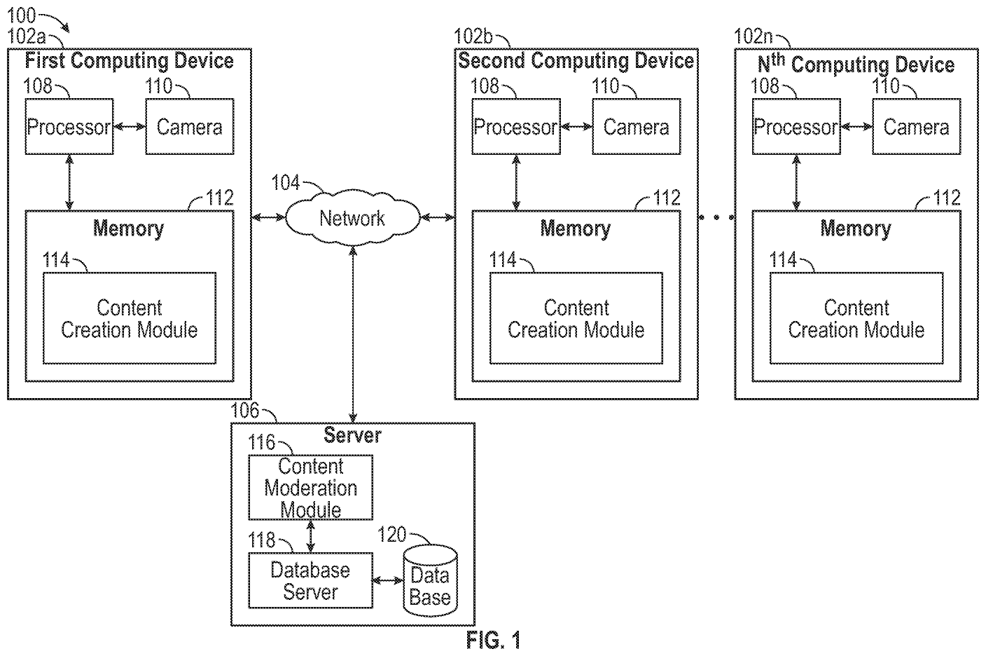

Referring to FIG. 1 is a block diagram depicting a schematic representation of a system for content creation and moderation in a digital platform, in accordance with one or more exemplary embodiments. The system 100 includes a first computing device 102a, a second computing device 102b, an nth computing 102n device, a network 104, a server 106, a processor 108, a camera 110, a memory 112, a content creation module 114, a content moderation module 116, a database server 118, and a database 120.

The computing devices 102a, 102b, 102n may include users' devices. The computing devices 102a, 102b, 102n may include, but is not limited to, a personal digital assistant, smartphones, personal computers, a mobile station, computing tablets, a handheld device, an internet enabled calling device, an internet enabled calling software, a telephone, a mobile phone, a digital processing system, and so forth. The computing devices 102a, 102b, 102n may include the processor 108 in communication with a memory 112. The processor 108 may be a central processing unit. The memory 112 is a combination of flash memory and random-access memory.

The first computing device 102a or the second computing device 102b or the nth computing device 102n may be connected to the one or more computing devices and the server 106 via the network 104. The network 104 may include, but not limited to, an Internet of things (IoT network devices), an Ethernet, a wireless local area network (WLAN), or a wide area network (WAN), a Bluetooth low energy network, a ZigBee network, a WWI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure. The network 104 may be configured to provide access to different types of users.

Although the first computing device 102a or second computing device 102b or the nth computing device 102n is shown in FIG. 1, an embodiment of the system 100 may support any number of computing devices. The first computing device 102 or second computing device 104 or the nth computing device 102n may be operated by the users. The users may include, but not limited to, an individual, a client, an operator, a content creator, and the like. The first computing device 102 or second computing device 104 or the nth computing device 102n supported by the system 100 is realized as a computer-implemented or computer-based device having the hardware or firmware, software, and/or processing logic needed to carry out the computer-implemented methodologies described in more detail herein.

In accordance with one or more exemplary embodiments of the present disclosure, the computing devices 102a, 102b, 102n includes the camera 110 may be configured to enable the user to capture the multimedia objects using the processor 108. The multimedia objects may include, but not limited to photos, videos, static images, photographs, dynamic images, looping images, looping videos, and the like. The computing devices 102a, 102b, 102n may include the content creation module 114 in the memory 112.

The content creation module 114 may be configured to enable the user or creator to create and share the content on the computing device. The content may include but, but not limited to photos, videos, text, graphical elements, and audio clips, and the like. The content creation module 114 may be any suitable applications downloaded from GOOGLE PLAY® (for Google Android devices), Apple Inc.'s APP STORE® (for Apple devices), or any other suitable database. The content creation module 114 may be desktop application which runs on Windows or Linux or any other operating system and may be downloaded from a webpage or a CD/USB stick etc. In some embodiments, the content creation module 114 may be software, firmware, or hardware that is integrated into the computing devices 102a, 102b, and 102n. The computing devices 102a, 102b, 102n may present a web page to the user by way of a browser, wherein the webpage comprises a hyper-link may direct the user to uniform resource locator (URL).

The server 106 may include the content moderation module 116, the database server 118, and the database 120. The content moderation module 116 may be configured to detect and analyze the user created and shared content. The content moderation module 116 may also be configured to provide badges to the user based on various topics. The content moderation module 116 may also be configured to provide server-side functionality via the network 104 to one or more users. The database server 118 may be configured to access the one or more databases. The database 120 may be configured to store user created and shared contents. The database 120 may also be configured to store interactions between the modules of the content creation module 114, and content moderation module 116.

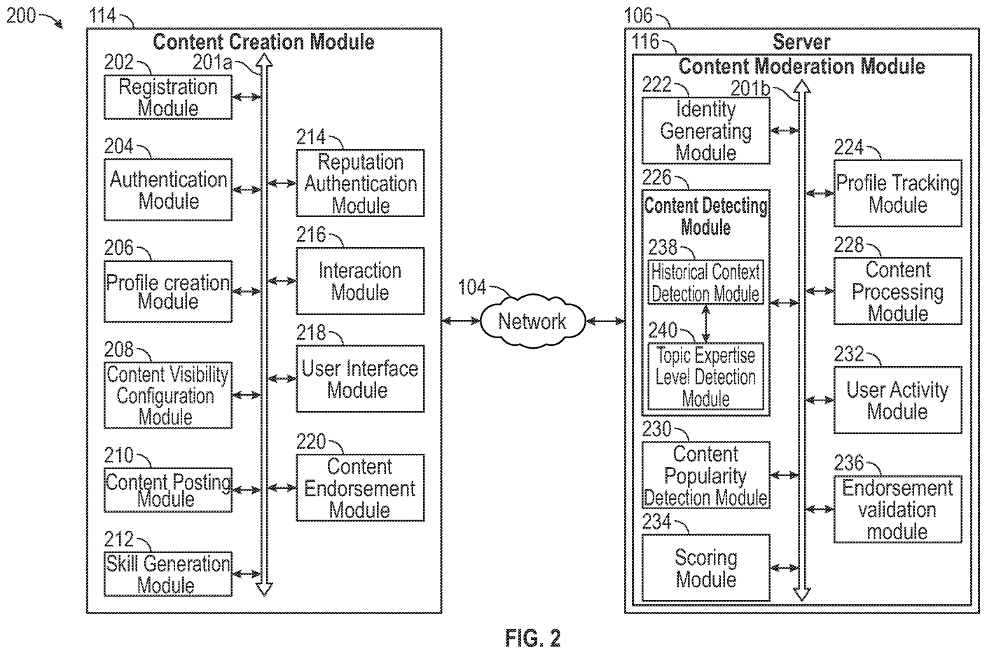

Referring to FIG. 2 is a block diagram 200 depicting an embodiment of the content creation module 114 on the computing devices and the content moderation module 116 on the server of shown in FIG. 1, in accordance with one or more exemplary embodiments. The content creation module 114 includes a bus 201a, a registration module 202, an authentication module 204, a profile creation module 206, a content visibility configuration module 208, a content posting module 210, a skill generation module 212, a reputation authentication module 214, an interaction module 216, a user interface module 218, and a content endorsement module 220. The bus 201a may include a path that permits communication among the modules of the content creation module 114 installed on the computing devices 102a, 102b, 102n. The term “module” is used broadly herein and refers generally to a program resident in the memory 112 of the computing devices 102a, 102b, 102n.

The registration module 202 may be configured to enable the user to register on the content creation module 114 installed on the computing devices by providing basic details of the user. The registration module 202 may be configured to enable the user to skip the registration process and allowing the user to access the content creation module 114 installed on the computing devices as the new user (guest user). The authentication module 204 may be configured to enable the user to login and access the content creation module 114 installed on the computing devices by using a user identity of the user. The profile creation module 206 may be configured to enable the user to create their profile on the content creation module 114 installed on the computing devices. The profile creation may include choosing an institution by the user, the institution chosen may be that of work, study, or some other affiliation. The profile creation module 206 may be configured to allowing the user to add their location in the user profile. The profile creation module 206 may be configured to enable the user to select topics on the contents. The content visibility configuration module 208 may be configured to enable the user to share the content either publicly or with select friends. The content posting module 210 may be configured to enable the user to share the particular content either anonymously or with the user identity. The step of choosing the anonymously or with the user identity may be done using a switch mode or a gesture on the camera 110 prior to creating the content. The content posting module 210 may be configured to enable the user to share the content in a visible mode with the user identity.

In accordance with one or more exemplary embodiments of the present disclosure, when the user posts the content in the anonymous mode, the user may not earn any topic expertise level. The topic expertise may include the user skills on the topics of the user posted content.

In accordance with one or more exemplary embodiments of the present disclosure, when the user posts the content in the anonymous mode, the user may earn the additional karma points.

In accordance with one or more exemplary embodiments of the present disclosure, the camera 110 shutter icon or combination of icons may indicate the chosen mode of the user while posting the content anonymously or with the user identity. When the user touches an anonymous mask, the user may be indicating that he wants to post anonymously. If the user subsequently touches the user identity, the user may be indicating that he wants to post as themselves. Touching the mask again may allow the user to select and assume different type of the mask. The type of the mask may further signify additional assumptions on the nature of anonymous identity.

The skill generation module 212 may be configured to enable the user to edit the own skills on the user profile. The skill generation module 212 may be configured to enable the user to edit the topics in order to correct any errors. The reputation authentication module 214 may be configured to allow the one or more end-users to judge the authenticity and trustworthiness of the content based on the topic expertise level and the historical context of the content creator on one or more topics by a reputation authentication module. The interaction module 216 may be configured to enable the one or more end users to interact with the user or content creator and access the content creator's content. The user interface module 218 may be configured to display the user created contents to the end users. The content endorsement module 220 may be configured to detect endorsement of the user expertise levels on the user created topics. The endorsements may be explicit in nature, where the end users may endorse the content creator for specific topics. These endorsements may also be implicit based on the interactions observed on the content.

In accordance with one or more exemplary embodiments of the present disclosure, the content moderation module 116 includes a bus 201b, an identity generating module 222, a profile tracking module 224, a content detecting module 226, a content processing module 228, a content popularity detection module 230, a user activity module 232, a scoring module 234, an endorsement validation module 236, a historical content detection module 238, a topic expertise level detection module 240. The bus 201b may include a path that permits communication among the modules of the content moderation module 116 installed on the sever 106.

In accordance with one or more exemplary embodiments of the present disclosure, the identity generating module 222 may be configured to generate a unique user identity for the user by obtaining a username or pseudonym from the user or obtaining from the registration module 202.

In accordance with one or more exemplary embodiments of the present disclosure, the profile tracking module 224 may be configured to verify the unique user identity of the user. The process of verifying the user identity may happen via using an existing system of real identity may include fakebook id and the like, using a physical identification, the physical identification may include but not limited to driving license, student id or passport and the like. The profile tracking module 224 may be configured to track the location of the user and updating the user profile to a certain level based on the detected presence of the user at the user location. The profile tracking module 224 may be configured to detect the user interactions with other end users and update the user profile level based on the detected interactions of the user. The profile tracking module 224 may be configured to display the user profile to other end users. The profile tracking module 224 may be configured to detect the evidence of external validation of the user expertise level on the topics.

In accordance with one or more exemplary embodiments of the present disclosure, the proof of external validation of the user's posts on a topic may also be used to determine the user's reputation. In one variation of the solution, the social distance between the current user and end user who may be liking, reacting, frosting, and commenting on the current user's content may be used as one of the factors. In this case, the social distance is determined by whether the two users are directly connected to each other or connected via a common friend or connected to two people who are themselves connected, and so on. The social distance may be further used to determine opinion bias or lack thereof. The social distance may impact the score in either direction depending on the context. In one variation, the shorter the social distance the better, but in another variation, the longer the social distance the better.

In accordance with one or more exemplary embodiments of the present disclosure, the proof of external validation of the user skills may include but not limited to an academic degree on the topic (e.g., a PhD in political science), work roles (e.g., an accredited, award winning journalist, published writer, award winning author, or best-selling author), competition based accomplishments (e.g., science olympiad winner or participant) or other identities and accomplishments indicative of the user's expertise.

In accordance with one or more exemplary embodiments of the present disclosure, the content detecting module 226 may be configured to detect user created content and identifying the topic of the user created content using topic detection techniques. The topic detection techniques may include metadata detection technique, text detection technique, imagery detection technique, audio detection technique, shapes detection technique, user input detection technique. The content detecting module 226 may be configured to identify one or more primary topics related to the user created content. The content detecting module 226 may be configured to track the user created content based on the topics over various periods.

In accordance with one or more exemplary embodiments of the present disclosure, the meta data detection technique may be configured to detect metadata in stickers or filters or other graphical elements, the graphical elements may have metadata associated with them identifying one or more topics they may be associated with. When several graphical elements are used, several factors may be used to identify the primary topics the content belongs to such as the majority topic, user's typical topic interests, intersection of topics among the graphical elements used and so forth.

In accordance with one or more exemplary embodiments of the present disclosure, the text detection technique may be configured to detect topic from text based on keywords used in the textual content can be indicative of topics and topic extraction algorithms may be used to extract the relevant ones.

In accordance with one or more exemplary embodiments of the present disclosure, the imagery detection technique may be configured to detect topic from imagery the topics may also been determined by an image analysis on photo or video content.

In accordance with one or more exemplary embodiments of the present disclosure, the audio detection technique may be configured to detect topic from an audio or the audio present in the content may be analyzed for keywords, from which the topics may be extracted.

In accordance with one or more exemplary embodiments of the present disclosure, the shapes detection technique may be configured to detecting shapes, doodles and other gestures that may have gone into creating the content may be used to understand topics.

In accordance with one or more exemplary embodiments of the present disclosure, the user input detection technique may be configured to detect user input, the users may explicitly set topics at the time of content creation or afterwards. Other users viewing the content may also suggest or set topics.

In accordance with one or more exemplary embodiments of the present disclosure, the content processing module 228 may be configured to hide the identity and profile of the user when the user posts the content in the anonymous mode. the content processing module 228 may be configured to mask the shared content automatically when the user posts the content in the anonymous mode. The masked content may be revealed upon an explicit interaction (e.g., a touch or swipe) indicative of consent to viewing the content.

In accordance with one or more exemplary embodiments of the present disclosure, the content popularity detection module 230 may be configured to detect popularity and nature of interactions of the user created content. The content popularity detection module 230 may be configured to detect the popularity of the user created content using popularity detection techniques. The popularity detection techniques may include volume and intensity detection technique, reactions detection technique, ratings detection technique, frost and defrost detection technique, voting detection technique, view detection technique, screenshot detection technique.

In accordance with one or more exemplary embodiments of the present disclosure, the volume and intensity detection technique may be configured to detect volume of intensity of the likes on the content. The volume of the likes may include the number of people that liked the content, while the intensity refers to the extent to which people liked the content. The intensity of the likes may be expressed with a deep like, using a gesture such as touch and hold on a screen.

In accordance with one or more exemplary embodiments of the present disclosure, the reactions detection technique may be configured to detect reaction recorded on the content. The reactions may include stickers or doodles added to the content-by-content end users, reflecting various sentiments. Metadata in stickers or other graphical elements may be indicative of the positivity or negativity of the reaction as well as any further depth in the reactions themselves. For example, a two-star sticker used on a restaurant photo may be indicative of how the user wanted to rate the restaurant.

In accordance with one or more exemplary embodiments of the present disclosure, the ratings detection technique may be configured to detect ratings on the content. The ratings may be used to gauge the sentiments towards the content as well.

In accordance with one or more exemplary embodiments of the present disclosure, the frost and defrost detection technique may be configured to detect frost and defrost actions on the content. The content end users may choose to frost or defrost content in order to hide sensitive or controversial content. This action may serve as an indicator of popularity. It should be noted that popularity is independent of the nature of the content itself and it is possible for controversial content to be popular.

In accordance with one or more exemplary embodiments of the present disclosure, the voting detection technique may be configured detect any upvotes and downvotes on the content.

In accordance with one or more exemplary embodiments of the present disclosure, view detection technique may be configured to detect views on the content. The number of views on the content received may also indicate the level of popularity.

In accordance with one or more exemplary embodiments of the present disclosure, screenshot detection technique may be configured to detect screenshots or number of shares on the content. The actions may include screenshots, saving of content and sharing to other users on the same platform or another, the factors may also indicate the level of popularity.

In accordance with one or more exemplary embodiments of the present disclosure, the user activity module 232 may be configured to sorting the topics of the user created content based on activity levels. The activity levels may be gauged by volume, consistency, and recency of activity by the user on those topics. Topics that have had activity levels below a certain threshold may be deprioritized. The threshold may be determined as a function of volume, consistency, or recency or some combination of the two. Deprioritization may result in dormancy of those topic level achievements, resulting in those skills not being called out on the user's profile or posts, when viewed by other users in the system. Deprioritized topics may be prioritized again if subsequent activity is detected in future.

In accordance with one or more exemplary embodiments of the present disclosure, the scoring module 234 may be configured to generate karma points to the user after verifying the user with the user identity. The score module 234 may be configured to generate default karma points to the new user (guest user) of the content creation module 114 installed on the computing devices. The karma points may include positive or negative points depending on the behavior of the user as self-exhibited and as expressed by the end-users. The scoring module 234 may be configured to generate default score to the user created content.

In accordance with one or more exemplary embodiments of the present disclosure, the endorsement validation module 236 may be configured to deprioritizing the topics based on activity levels below the certain threshold may be deprioritized.

The historical content detection module 238 may be configured to identify the historical context of the user created content. The topic expertise level detection module 240 may be configured to detect the topic expertise level of the user based on the user created content.

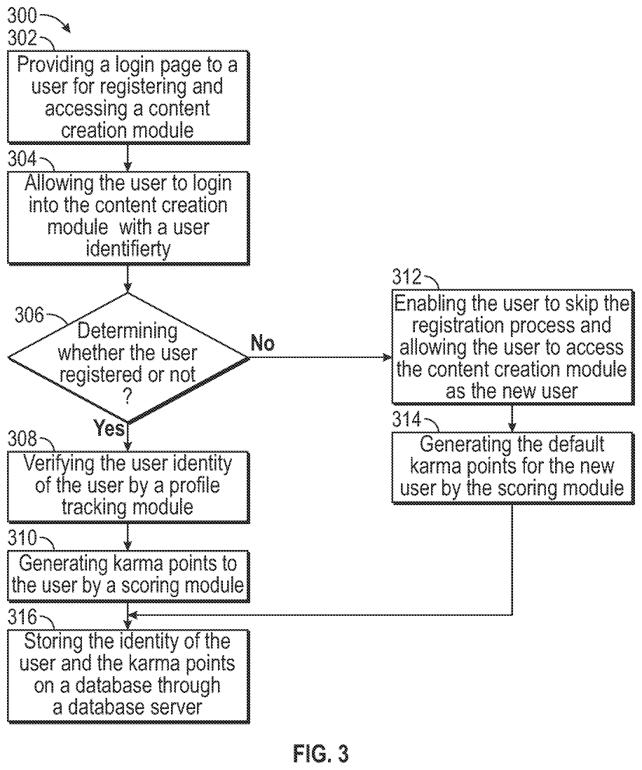

Referring to FIG. 3 is a flow diagram 300 depicting a method for registering and logging process into a content creation module with verified status and karma points, in accordance with one or more exemplary embodiments. The method 300 may be carried out in the context of the details of FIG. 1, and FIG. 2. However, the method 300 may also be carried out in any desired environment. Further, the aforementioned definitions may equally apply to the description below.

The method commences at step 302, providing the login page to the user for registering and accessing the content creation module. Thereafter, at step 304, allowing the user to login into the content creation module with the user identity. Determining whether the user registered or not, at step 306. If answer at step 306 is Yes, the method continues at step 308, verifying the user identity of the user by the profile tracking module. Thereafter, at step 310, generating karma points to the user by the scoring module. If answer at step 306 is No, the method continues at step 312, enabling the user to skip the registration process and allowing the user to access the content creation module as the new user. Thereafter, at step 314, generating the default karma points for the new user by the scoring module. Thereafter, at step 316, storing the identity of the user and the karma points on the database through the database server.

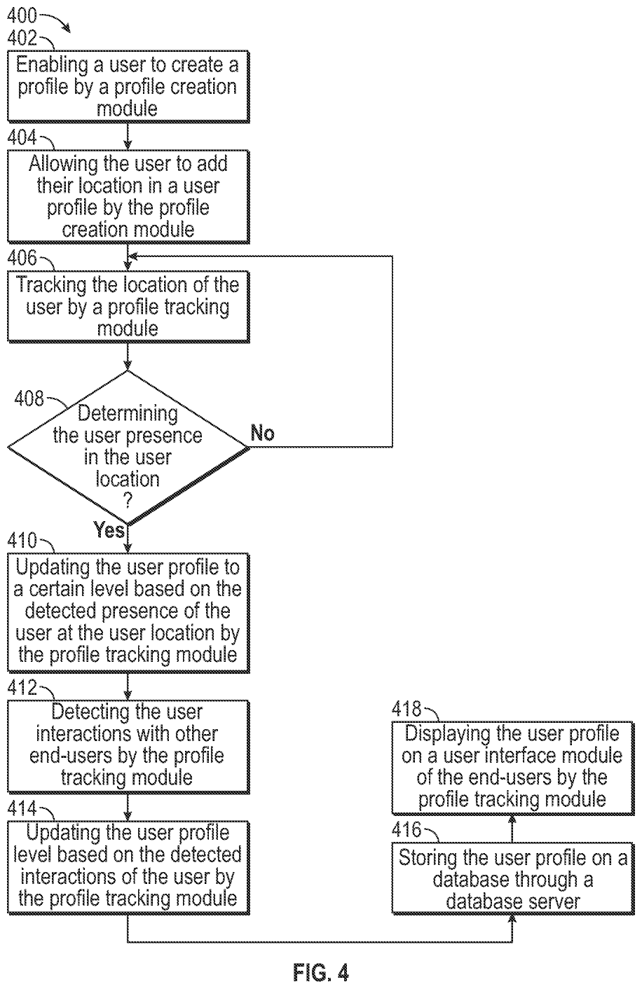

Referring to FIG. 4 is a flow diagram 400 depicting a method for establishing and verifying a user profile, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, enabling the user to create the profile by the profile creation module. Thereafter, at step 404, allowing the user to add their location in the user profile by the profile creation module. Thereafter, at step 406, tracking the location of the user by the profile tracking module. Determining the user presence in the user location, at step 408. If answer at step 408 is Yes, the method continues at step 410, updating the user profile to a certain level based on the detected presence of the user at the user location by the profile tracking module. Thereafter, at step 412, detecting the user interactions with other end users by the profile tracking module. Thereafter, at step 414, updating the user profile level based on the detected interactions of the user by the profile tracking module. Thereafter, at step 416, storing the user profile on the database through the database server. Thereafter, at step 418, displaying the user profile on the user interface module of the end users by the profile tracking module. If answer at step 408 is No, the method reverts at step 406.

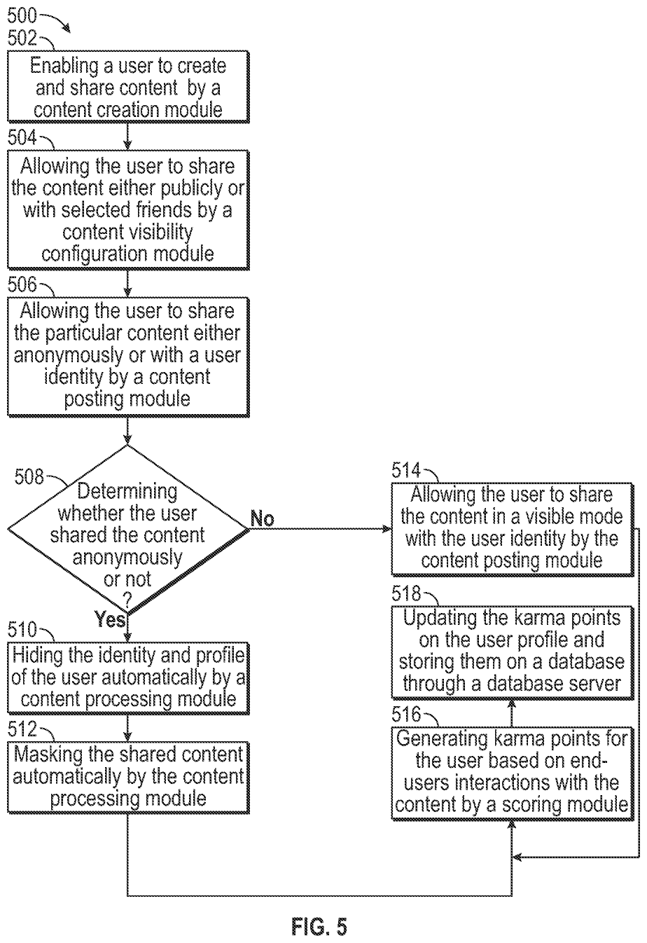

Referring to FIG. 5 is a flow diagram 500 depicting a method for posting content in the content creation module 114 on the computing devices, in accordance with one or more exemplary embodiments. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The method commences at step 502, enabling the user to create and share content by the content creating module. Thereafter, at step 504, allowing the user to share the content either publicly or with selected friends by the content visibility configuration module. Thereafter, at step 506, allowing the user to share the particular content either anonymously or with the user identity by the content posting module. Determining whether the user shared the content anonymously or not, at step 508. If answer at step 508 is Yes, the method continues at step 510, hiding the identity and profile of the user automatically by the content processing module. Thereafter, at step 512, masking the shared content automatically by the content processing module. If answer at step 508 is No, the method continues at step 514, allowing the user to share the content in the visible mode with the user identity by the content posting module. Thereafter, at step 516, generating the karma points for the user based on other end users' interactions with the content by the scoring module. Thereafter, at step 518, updating the karma points on the user profile and storing them on the database through the database server.

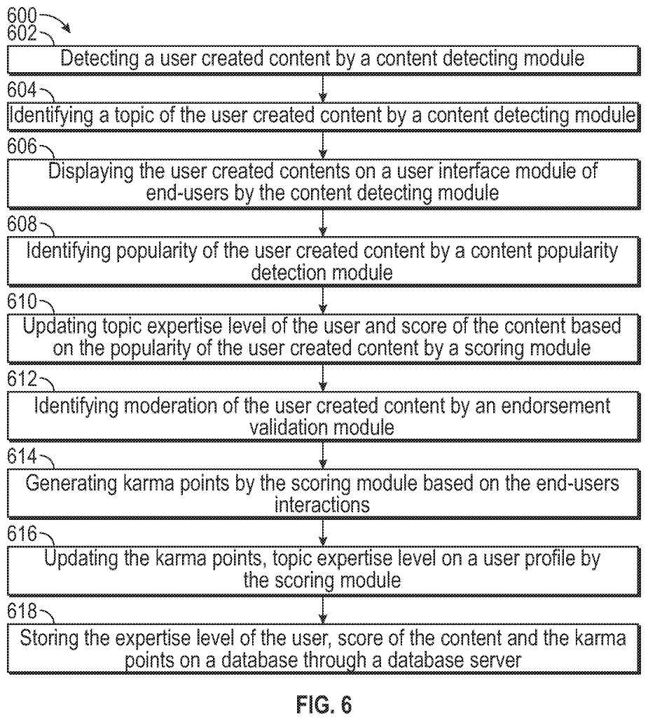

Referring to FIG. 6 is a flow diagram 600 depicting a method for updating a user skills and karma points based on posted content, in accordance with one or more exemplary embodiments. The method 600 may be carried out in the context of the details of FIG. 1, FIG. 2, FIG. 3, FIG. 4, and FIG. 5. However, the method 600 may also be carried out in any desired environment. Further, the aforementioned definitions may equally apply to the description below.

The method commences at step 602, detecting the user created content by the content detection module. Thereafter, at step 604, identifying the topic of the user created content by the content detecting module. Thereafter, at step 606, displaying the user created contents on the user interface module of the end users by the content detecting module. Thereafter, at step 608, identifying popularity of the user created content by the content popularity detection module. Thereafter, at step 610, updating the topic expertise level of the user and score of the content based on the popularity of the user created content by the scoring module. Thereafter, at step 612, identifying moderation of the user created content by the endorsement validation module. Thereafter, at step 614, generating the karma points by the scoring module based on the end users' interactions. Thereafter, at step 616, updating the karma points, topic expertise level on the user profile by the scoring module. Thereafter, at step 618, storing the expertise level of the user, score of the content and the karma points on the database through the database server.

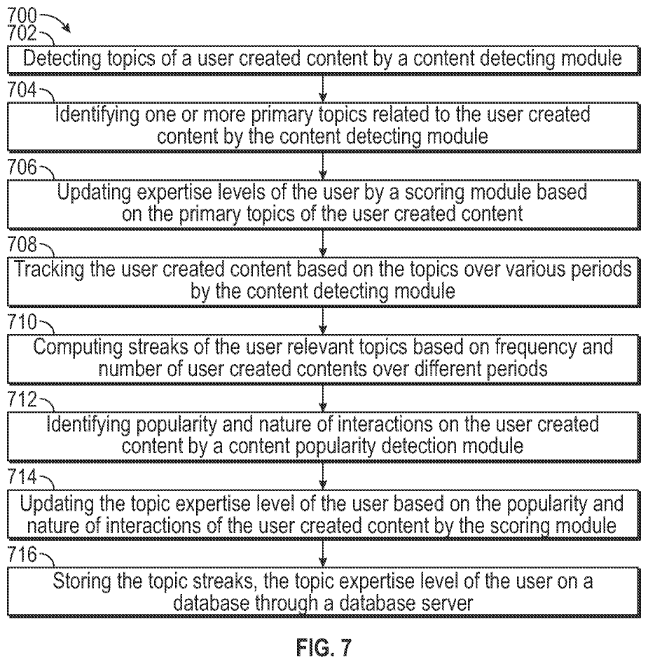

Referring to FIG. 7 is a flow diagram 700 depicting a method for automatically detecting the user skills based on posted content, in accordance with one or more exemplary embodiments. The method 700 may be carried out in the context of the details of FIG. 1, FIG. 2, FIG. 3, FIG. 4, FIG. 5, and FIG. 6. However, the method 700 may also be carried out in any desired environment. Further, the aforementioned definitions may equally apply to the description below.

The method commences at step 702, detecting the topics of the user created content by the content detecting module. Thereafter, at step 704, identifying one or more primary topics related to the user created content by the content detecting module. Thereafter, at step 706, updating the expertise levels of the user by the scoring module based on the primary topics of the user created content. Thereafter, at step 708, tracking the user created content based on the topics over various periods by the content detecting module. Thereafter, at step 710, computing streaks of the user relevant topics based on the frequency and number of users created contents over the different periods. Thereafter, at step 712, Identifying the popularity and nature of interactions on the user created content by the content popularity detection module. Thereafter, at step 714, updating the topic expertise level of the user based on the popularity and nature of interactions of the user created content by the scoring module. Thereafter, at step 716, storing the topic streaks, the topic expertise level of the user on the database through the database server.

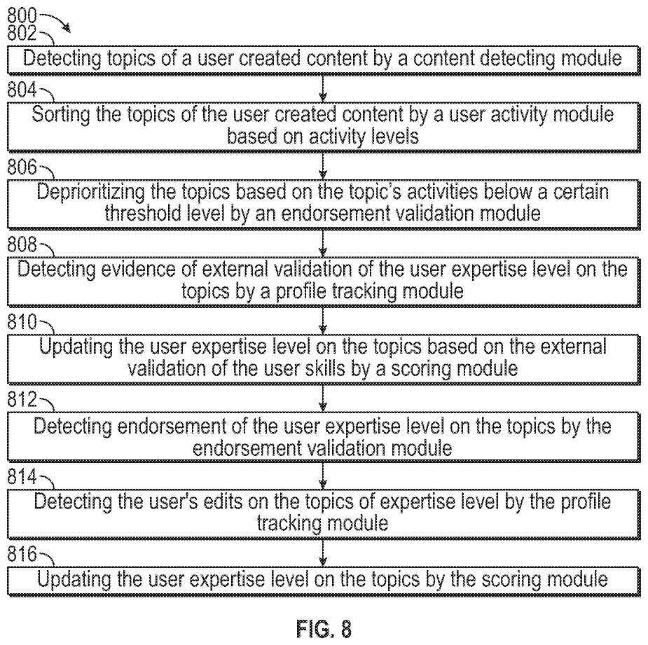

Referring to FIG. 8 is a flow diagram 800 depicting a method for automatically correcting the user skills, in accordance with one or more exemplary embodiments. The method 800 may be carried out in the context of the details of FIG. 1, FIG. 2, FIG. 3, FIG. 4, FIG. 5, FIG. 6, and FIG. 7. However, the method 800 may also be carried out in any desired environment. Further, the aforementioned definitions may equally apply to the description below.

The method commences at step 802, detecting the topics of the user created content by the content detecting module. Thereafter, at step 804, sorting the topics of the user created content by the user activity module based the activity levels. Thereafter, at step 806, deprioritizing the topics based on the topic's activities below the certain threshold level by the endorsement validation module. Thereafter, at step 808, detecting evidence of external validation of the user expertise level on the topics by the profile tracking module. Thereafter, at step 810, updating the user expertise level on the topics based on the external validation of the user skills by the scoring module. Thereafter, at step 812, detecting endorsement of the user expertise level on the topics by the endorsement validation module. Thereafter, at step 814, detecting the user's edits on the topics of expertise level by the profile tracking module. Thereafter, at step 816, updating the user expertise level on the topics by the scoring module.

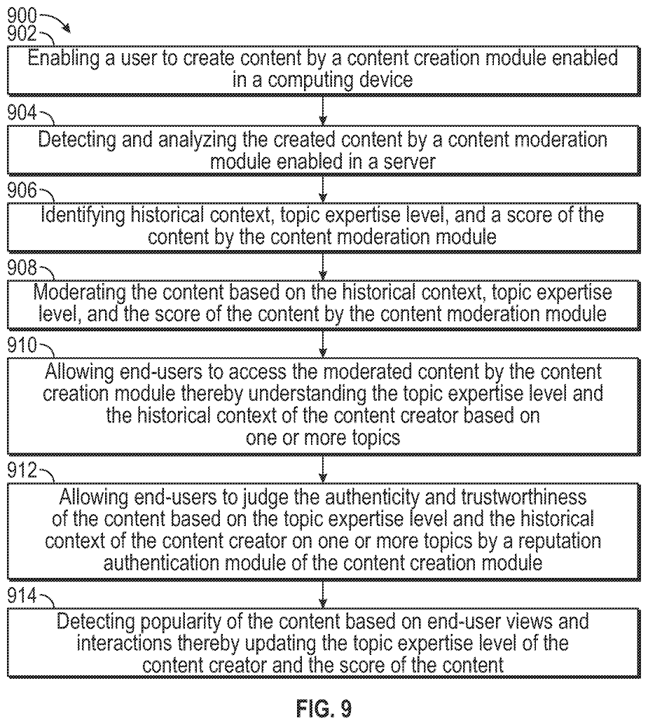

Referring to FIG. 9 is a flow diagram 900 depicting a method for content creation and moderation in a digital platform, in accordance with one or more exemplary embodiments. The method 800 may be carried out in the context of the details of FIG. 1, FIG. 2, FIG. 3, FIG. 4, FIG. 5, FIG. 6, FIG. 7, and FIG. 8. However, the method 800 may also be carried out in any desired environment. Further, the aforementioned definitions may equally apply to the description below.

The method commences at step 902, enabling the user to create content by the content creation module enabled in the computing device. Thereafter, at step 904, detecting and analyzing the created content by the content moderation module enabled in the server. Thereafter, at step 906, identifying the historical context, the topic expertise level, and the score of the content by the content moderation module. Thereafter, at step 908, moderating the content based on the historical context, the topic expertise level, and the score of the content by the content moderation module. Thereafter, at step 910, allowing the end-users to access the moderated content by the content creation module thereby understanding the topic expertise level and the historical context of the content creator based on one or more topics. Thereafter, at step 912, allowing end-users of the content to judge the authenticity and trustworthiness of the content based on the topic expertise level and the historical context of the content creator on one or more topics by the reputation authentication module of the content creation module. Thereafter, at step 914, detecting popularity of the content based on end-users' views and interactions thereby updating the topic expertise level of the content creator and the score of the content.

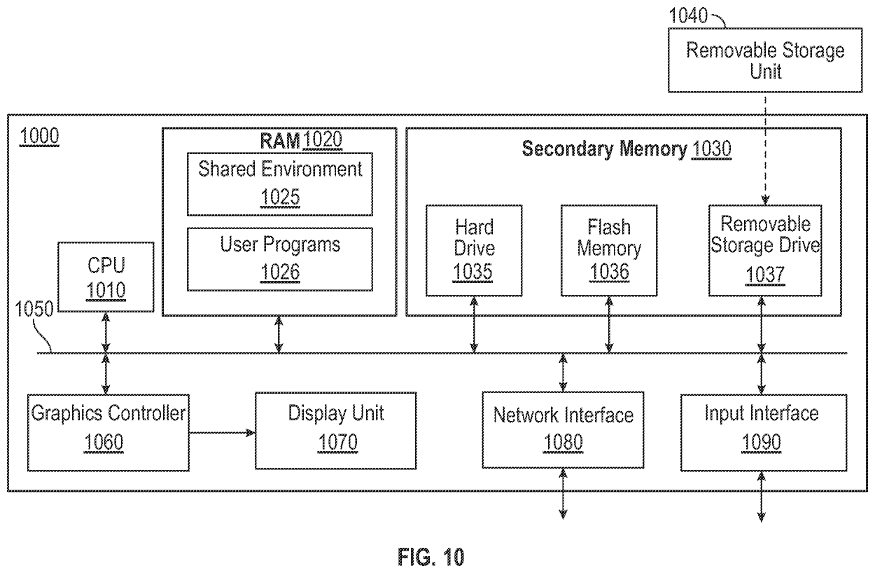

Referring to FIG. 10 is a block diagram 1000 illustrating the details of a digital processing system 1000 in which various aspects of the present disclosure are operative by execution of appropriate software instructions. The Digital processing system 1000 may correspond to the first computing devices 102a,102b, 102n (or any other system in which the various features disclosed above can be implemented).

Digital processing system 1000 may contain one or more processors such as a central processing unit (CPU) 1010, random access memory (RAM) 1020, secondary memory 1030, graphics controller 1060, display unit 1070, network interface 1080, and input interface 1090. All the components except display unit 1070 may communicate with each other over communication path 1050, which may contain several buses as is well known in the relevant arts. The components of FIG. 10 are described below in further detail.

CPU 1010 may execute instructions stored in RAM 1020 to provide several features of the present disclosure. CPU 1010 may contain multiple processing units, with each processing unit potentially being designed for a specific task. Alternatively, CPU 1010 may contain only a single general-purpose processing unit.

RAM 1020 may receive instructions from secondary memory 1030 using communication path 1050. RAM 1020 is shown currently containing software instructions, such as those used in threads and stacks, constituting shared environment 1025 and/or user programs 1026. Shared environment 1025 includes operating systems, device drivers, virtual machines, etc., which provide a (common) run time environment for execution of user programs 1026.

Graphics controller 1060 generates display signals (e.g., in RGB format) to display unit 1070 based on data/instructions received from CPU 1010. Display unit 1070 contains a display screen to display the images defined by the display signals. Input interface 1090 may correspond to a keyboard and a pointing device (e.g., touchpad, mouse) and may be used to provide inputs. Network interface 1080 provides connectivity to a network (e.g., using Internet Protocol), and may be used to communicate with other systems (such as those shown in FIG. 1) connected to the network 104.

Secondary memory 1030 may contain hard drive 1035, flash memory 1036, and removable storage drive 1037. Secondary memory 1030 may store the data software instructions (e.g., for performing the actions noted above with respect to the Figures), which enable digital processing system 1000 to provide several features in accordance with the present disclosure.

Some or all of the data and instructions may be provided on removable storage unit 1040, and the data and instructions may be read and provided by removable storage drive 1037 to CPU 1010. Floppy drive, magnetic tape drive, CD-ROM drive, DVD Drive, Flash memory, removable memory chip (PCMCIA Card, EEPROM) are examples of such removable storage drive 1037.

Removable storage unit 1040 may be implemented using medium and storage format compatible with removable storage drive 1037 such that removable storage drive 1037 can read the data and instructions. Thus, removable storage unit 1040 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 1040 or hard disk installed in hard drive 1035. These computer program products are means for providing software to digital processing system 1000. CPU 1010 may retrieve the software instructions and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 1030. Volatile media includes dynamic memory, such as RAM 1020. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 1050. Transmission media can also take the form of acoustic or light waves, such as those generated during radio-wave and infra-red data communications.

According to an exemplary aspect of the present disclosure, enabling a user or creator to create content by a content creation module 114 enabled in a computing device.

According to an exemplary aspect of the present disclosure, detecting and analyzing the created content by a content moderation module 116 enabled in the server 106.

According to an exemplary aspect of the present disclosure, identifying historical context, topic expertise level, and a score of the content by the content moderation module 116.

According to an exemplary aspect of the present disclosure, moderating the content based on the historical context, topic expertise level, and the score of the content by the content moderation module 116.

According to an exemplary aspect of the present disclosure, allowing one or more end-users to access the moderated content by the content creation module 114 thereby understanding the topic expertise level and the historical context of the content creator based on one or more topics.

According to an exemplary aspect of the present disclosure, allowing the one or more end-users to judge the authenticity and trustworthiness of the content based on the topic expertise level and the historical context of the content creator on one or more topics by the reputation authentication module 214 of the content creation module 114.

According to an exemplary aspect of the present disclosure, detecting popularity of the content based on the one or more end-users views and interactions thereby updating the topic expertise level of the content creator and the score of the content.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A method for content creation and moderation in a digital platform, comprising:
enabling a user or creator to create content by a content creation module enabled in a computing device;
detecting and analyzing the created content by a content moderation module enabled in a server;
identifying historical context, topic expertise level, and a score of the content by the content moderation module;
moderating the content based on the historical context, topic expertise level, and the score of the content by the content moderation module;
allowing one or more end-users to access the moderated content by the content creation module thereby understanding the topic expertise level and the historical context of the content creator based on one or more topics;
allowing the one or more end-users to judge the authenticity and trustworthiness of the content based on the topic expertise level and the historical context of the content creator on one or more topics by a reputation authentication module of the content creation module; and
detecting popularity of the content based on the one or more end-users views and interactions thereby updating the topic expertise level of the content creator and the score of the content.

2. The method of claim 1, comprising a step of enabling the user to register or continue as the new user (guest user) by a registration module.

3. The method of claim 2, comprising a step of generating karma points to the registered user and the new user (guest user) by a scoring module.

4. The method of claim 1, comprising a step of enabling the user to share the created content as at least one of: anonymously; a user identity by a content posting module.

5. The method of claim 1, comprising a step of enabling the user to create a profile and allow the user to add their current location in a user profile by a profile creation module.

6. The method of claim 5, comprising a step of tracking the user presence in the location by a profile tracking module and updating the user profile to a certain level based on the detected presence of the user at the user location.

7. The method of claim 1, comprising a step of allowing the user to share the created content as at least one of: publicly; with selected friends by a content visibility configuration module.

8. The method of claim 1, comprising a step of allowing the user to post the created content in a special mode that only appears after a touch and is otherwise masked, partially, or fully invisible by the content posting module.

9. The method of claim 1, comprising a step of detecting topics of the user created content and generating one or more badges based on the topics of the user created content by a content detecting module.

10. The method of claim 9, comprising a step of detecting the topics of the user created content using topic detection techniques.

11. The method of claim 10, comprising a step of detecting metadata in stickers, filters or other graphical elements used in the content by a meta data detection technique.

12. The method of claim 10, comprising a step of detecting the topics from text by based on keywords used in the textual content by a text detection technique.

13. The method of claim 10, comprising a step of detecting the topics from photo or video content by an imagery detection technique.

14. The method of claim 10, comprising a step of detecting the topics from audio present in the content by an audio detection technique.

15. The method of claim 10, comprising a step of detecting the topics from doodles and gestures by a shapes detection technique.

16. The method of claim 1, comprising a step of detecting popularity and nature of interactions of the user created content using popularity detection techniques.

17. The method of claim 16, comprising a step of detecting an intensity of likes on the content by a volume and intensity detection technique.

18. The method of claim 16, comprising a step of detecting reactions recorded on the content by a reactions detection technique.

19. A system for content creation and moderation in a digital platform, comprising:
one or more computing devices configured to establish communication with a server over a network, whereby the one or more computing device comprises a memory configured to store multimedia objects captured using a camera;
the one or more computing devices comprises a content creation module configured to enable a user or creator to create a content; wherein the content creation module configured to enable one or more end-users to access the user created content, the content creation module configured to enable the one or more end-users to judge the authenticity and trustworthiness of the user created content;
the server comprises a content moderation module configured to detect and analyze the user created content, wherein the content moderation module configured to identify historical context, topic expertise level, and a score of the user created content; and
the content moderation module configured to moderate the content based on the historical context, topic expertise level, and the score of the content, whereby the content moderation module configured to detect popularity of the content based on one or more end-users' views and interactions, and updates the topic expertise level of the content creator and the score of the content.

20. A computer program product comprising a non-transitory computer-readable medium having a computer-readable program code embodied therein to be executed by one or more processors, said program code including instructions to:
enable a user or creator to create content by a content creation module enabled in a computing device;
detect and analyze the created content by a content moderation module enabled in a server;
identify historical context, topic expertise level, and a score of the content by the content moderation module;
moderate the content based on the historical context, topic expertise level, and the score of the content by the content moderation module;
allow one or more end-users to access the moderated content by the content creation module and enable one or more end-users to understand the topic expertise level and the historical context of the content creator based on one or more topics;
allow the one or more end-users to judge the authenticity and trustworthiness of the content based on the topic expertise level and the historical context of the content creator on one or more topics by a reputation authentication module of the content creation module; and
detect popularity of the content based on the one or more end-users' views and interactions thereby updating the topic expertise level of the content creator and the score of the content.
